(19) United States
(12) Patent Application Publication
(10) Pub. No.: US 2012/0119049 A1
(43) Pub. Date: May 17, 2012

(54) DEVICE FOR ROTATABLY MOUNTING AT LEAST ONE MEDICAL APPARATUS ON A FLOOR AND A METHOD FOR SLOWING DOWN AND/OR LOCKING A ROTARY UNIT OF THE DEVICE

(75) Inventor: Georg Marx, Weingarten (DE)

(73) Assignee: Maquet GmbH & Co. KG, Rastatt (DE)

(21) Appl. No.: 13/383,704

(22) PCT Filed: Jul. 1, 2010
(86) PCT No.: PCT/EP2010/059360

§ 371 Date: Jan. 27, 2012

(30) Foreign Application Priority Data
Jul. 13, 2009 (DE) 10 2009 032 844.0

(51) Int. Cl. F16M 13/02

(52) U.S. Cl. 248/346.06

(57) ABSTRACT

The invention relates to a device (10, 38) for rotatably mounting at least one medical apparatus on a floor. The device (10, 38) comprises a floor unit (12) which can be firmly connected to the floor and a rotary unit (16) which is connected to the floor unit (12) rotatably relative thereto via at least one bearing unit (14). Further, the device (10, 38) comprises at least one locking element (24, 26) firmly connected to the rotary unit (16) for slowing down and for locking the rotary unit (16). The locking element (24, 26) presses in a braking state against the floor unit (12) for lifting the rotary unit (16), wherein, as a result of the lifting, the contact area of the rotary unit (16) contacts a contact area of the floor unit (12) for producing a braking torque. The invention further relates to a method for slowing down and/or locking the rotary unit (16) of the device (10, 38).

### CROSS REFERENCE TO RELATED APPLICATIONS

This application is entitled to the benefit of and incorporates by reference essential subject matter disclosed in International Patent Application No. PCT/EP2010/059360 filed on Jul. 1, 2010 and German Patent Application No. 10 2009 032 844.0 filed Jul. 13, 2009.

### FIELD OF THE INVENTION

The invention relates to a device for rotatably mounting at least one medical apparatus on a floor. The device comprises a floor unit which can be firmly connected to the floor and a rotary unit which is connected to the floor unit rotatably relative thereto about an axis of rotation via at least one bearing unit. The device further comprises a locking element firmly connected to the rotary unit for slowing down and/or locking the rotary unit. The invention further relates to a method for slowing down and/or locking the rotary unit of the device.

### BACKGROUND OF THE INVENTION

A device of this type is in particular used as a rotary base for operating tables. In the case of known rotary bases for operating tables, the rotary unit which is rotatable relative to the floor unit is slowed down and/or locked in that one or more cylinders firmly connected to the rotary unit press against a contact area of the floor unit and thus produce a braking torque between the floor unit and the rotary unit. This, however, has the disadvantage that this braking torque is relatively low due to the small distance from the cylinders to the axis of rotation.

### SUMMARY OF THE INVENTION

It is the object of the invention to specify a device for rotatably mounting at least one medical apparatus on a floor and a method for slowing down and/or locking a rotary unit of a device for rotatably mounting at least one medical apparatus on a floor, in which the rotary unit and the medical apparatus connected thereto can be reliably slowed down and locked relative to a floor unit in an easy manner.

This object is solved by a device having a device for rotatably mounting at least one medical apparatus on a floor, comprising a floor unit which can be firmly connected to the floor, a rotary unit which is connected to the floor unit rotatably relative thereto about an axis of rotation via at least one bearing unit, and at least one locking element which is firmly connected to the rotary unit for slowing down the rotary unit and for locking the rotary unit, wherein the locking element, in a braking state, presses against the floor unit for lifting the rotary unit, and wherein, as a result of the lifting, a contact area of the rotary unit contacts a contact area of the floor unit for producing a braking torque, wherein the floor unit comprises a base unit and a braking ring, in that the contact area of the floor unit is formed by the braking ring, in that the rotary unit has a groove extending in circumferential direction, in that the contact area of the rotary unit is formed by at least a part of at least one inner surface of the groove, and in that at least a part of the braking ring is arranged within the groove and a method for slowing down and/or locking a rotary unit of a device for rotatably mounting at least one medical apparatus on a floor, in which the rotary unit which is connected to the floor unit rotatably relative thereto about an axis of rotation via at least one bearing unit is lifted by means of at least one locking element, wherein the floor unit can be firmly connected to the floor, and in which, as a result of the lifting, a contact area of the rotary unit is pressed against a contact area of the floor unit that is complementary to the contact area of the rotary unit for generating a frictional force, wherein a floor unit is used which comprises a base unit and a braking ring, wherein the contact area of the floor unit is formed by the braking ring, in that in the rotary unit a groove extending in circumferential direction is provided, wherein the contact area of the rotary unit is formed by at least a part of at least one inner surface of the groove, and in that at least a part of the braking ring is arranged within the groove. Advantageous developments of the invention are specified in the dependent claims.

According to the invention, the locking element presses against the floor unit in the braking state. The rotary unit is lifted thereby. As a result of this lifting, a contact is established between a contact area of the rotary unit and a contact area of the floor unit, and a braking torque is produced. By means of this braking torque, a secure locking of the rotary unit relative to the floor unit is achieved so that an unintentional rotation of the rotary unit relative to the floor unit is prevented. In particular, an unintentional rotation of the rotary unit relative to the floor unit as a result of the forces exerted on an operating table by the operating physicians during an operation of a patient lying on the operating table connected to the rotary unit is prevented. When the rotary unit is lifted while it rotates, then the rotary unit is slowed down by the braking torque. When the rotary unit does not rotate relative to the floor unit, then the braking torque causes the locking of the rotary unit. In this case, the braking torque is the torque which has to be overcome to overcome the locking of the rotary unit. The braking torque is thus also referred to as locking torque. For simplification, the torque caused by the contact between the contact area of the rotary unit and the contact area of the floor unit is always referred to in the following as braking torque, independent of whether the torque serves to slow down the rotary unit or to lock the rotary unit.

It is advantageous when the braking torque produced between the contact area of the rotary unit and the contact area of the floor unit is a first braking torque and when the locking element, when pressing against the floor unit, produces a second braking torque as a result of the frictional force acting between a contact area of the locking element and a contact area of the floor unit. Like the first braking torque, the second braking torque can serve both to slow down the rotary unit and to lock the rotary unit. By means of the additional braking torque the force required for releasing the locking of the rotary unit relative to the floor unit is increased, as a result whereof the reliability of the locking is further improved. The first braking torque is preferably higher than the second braking torque.

In addition, it is advantageous when the locking element is a first locking element and when at least one second locking element is provided. It is particularly advantageous when in addition to the first and the second locking element a third and at least a fourth locking element are provided. The radial distance from the center axes of the locking elements to the axis of rotation is preferably the same each time. By using several locking elements, a uniform lifting of the rotary unit relative to the floor unit is achieved so that the frictional forces generated by the contact between the contact area of the rotary unit and the contact area of the floor unit are uniformly distributed over the entire contact area. This in turn ensures that a uniform braking torque is produced over the entire contact area of the rotary unit. Further, by using several locking elements the forces to be generated by the individual locking elements are reduced so that the durability of the locking elements is increased.

In a preferred embodiment of the invention, the locking elements each comprise at least one cylinder. In a particularly preferred embodiment of the invention, the cylinders are hydraulic cylinders. By means of cylinders, the rotary unit can easily be displaced relative to the floor unit, i.e. be lifted, in that a contact area of each locking element is pressed against the floor unit by the cylinder. Further, by means of such cylinders large forces can be generated between the floor unit and the rotary unit so that also high braking torques can be produced.

The bearing unit preferably comprises a ball bearing. In particular, the bearing unit comprises a ball race by which a simple uniform rotatability of the rotary unit relative to the floor unit is achieved when the locking unit or the locking units do not press against the floor unit.

On the side of the rotary unit facing away from the floor unit, in particular an operating table can be mounted. By means of the device a rotatable mounting of the operating table relative to the floor of the operating room is achieved. By means of the high braking torque which can be obtained by means of the device, the operating table is reliably fixed during the operation so that no unintentional rotation of the operating table takes place, as a result whereof injuries to the patients are prevented.

In a particularly preferred embodiment of the invention the floor unit comprises a base unit and a braking ring. The contact area of the floor unit is formed by this braking ring. Further, it is advantageous when the rotary unit has a groove extending in circumferential direction and when the contact area of the rotary unit is formed by at least a part of at least an inner surface of the groove. At least a part of the braking ring is arranged within the groove. By lifting the rotary unit a part of the surface of the groove is pressed against the braking ring for producing the first braking torque. By arranging the braking ring within the groove, a translatory movement of the rotary unit relative to the floor unit is prevented. As the floor unit is made up of the base unit and the braking ring an easy assembly of the device is achieved. The braking ring in particular comprises three identical ring segments. In an alternative embodiment of the invention, the braking ring can also be formed in one piece. Likewise, the braking ring can also be formed of two or more than three ring segments.

It is advantageous when the coefficient of friction between the material of the rotary unit and the material of the braking ring is higher than the coefficient of friction between the material of the rotary unit and the material of the base unit. As a result thereof, a higher first braking torque is achieved and thus the locking effect is increased.

In a preferred embodiment of the invention, the radial distance from the center line of the contact area of the rotary unit to the axis of rotation is larger than the radial distance from the center point of the locking element to the axis of rotation. Thus it is achieved that the first braking torque is higher than the second braking torque. In particular, it is achieved in this way that a first braking torque as high as possible and thus a reliable locking of the rotary unit is achieved.

The rotary unit preferably has a rotationally symmetric circumferential surface. It is advantageous when the radial distance from the center line of the contact area of the rotary unit to the axis of rotation has a value in the range between 80% and 95% of the radius of the rotary unit. Thus, a relatively large distance between the contact area of the rotary unit and the axis of rotation is achieved. This large distance causes that a high braking torque is achieved by the contact between the contact area of the rotary unit and the contact area of the floor unit. Further, also the force required for an unintentional release of the locking of the rotary unit is increased.

It is advantageous when the contact area of the rotary unit and/or the contact area of the floor unit have an annular shape. Thus, a uniform distribution of the frictional forces over the entire contact area is achieved, and high braking torques can be produced.

The floor unit is preferably firmly connected to the floor via suitable screw connections, in particular by means of dowel pins or threaded rods glued into the floor.

A further aspect of the invention relates to a method for slowing down and/or locking a rotary unit of a device for rotatably mounting at least one medical apparatus on a floor. In the method, the rotary unit which is connected to the floor unit rotatably relative thereto about an axis of rotation via at least one bearing unit is lifted by means of at least one locking element, wherein the floor unit can be firmly connected to the floor. As a result of the lifting, a contact area of the rotary unit is pressed against a contact area of the floor unit that is complementary to the contact area of the rotary unit for generating a frictional force. By means of the braking torque caused by the frictional force, a reliable locking of the rotary unit relative to the floor unit or a reliable slowing down of the rotary unit relative to the floor unit is achieved.

The method specified by the independent method claim can be developed in the same manner as the device according to claim 1. In particular, the method can be developed with the features specified in those claims which are dependent on the independent device claim or with respective method features.

### BRIEF DESCRIPTION OF THE DRAWINGS

Further features and advantages of the invention result from the following description which in connection with the enclosed Figures explains the invention in more detail with reference to embodiments.

FIG. 1 shows a schematic sectional view of a device for rotatably mounting at least one medical apparatus on a floor.

FIG. 2 shows a schematic bottom view of the device according to FIG. 1 without base unit.

FIG. 3 shows a schematic sectional view of a device for rotatably mounting at least one medical apparatus according to a further embodiment of the invention.

### DETAILED DESCRIPTION OF THE PREFERRED EMBODIMENTS

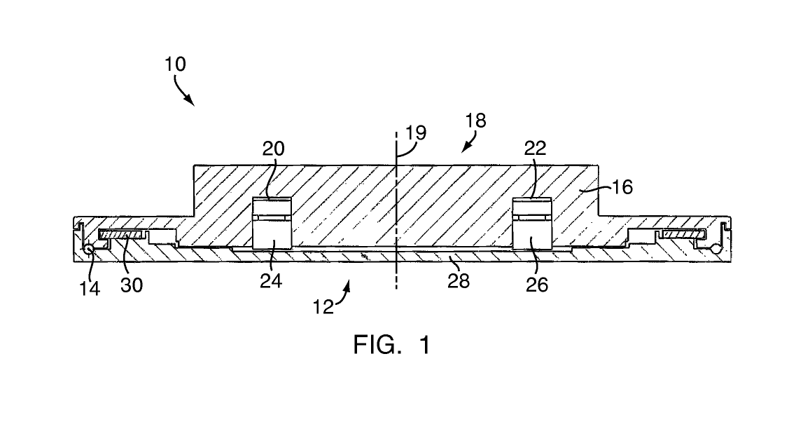

In FIG. 1, a schematic sectional view of a device 10 for rotatably mounting at least one medical apparatus on a floor is illustrated. The device 10 comprises a floor unit 12 and a rotary unit 16 connected to the floor unit 12 rotatably relative thereto via a ball race 14. The floor unit 12 contacts with the support surface facing away from the rotary unit 16 a floor that is not illustrated in FIG. 1. The floor unit 12 is firmly connected to the floor in particular via a plurality of screws so that the floor unit 12 cannot move relative to the floor, in particular it cannot rotate.

To the upper side 18 of the rotary unit 16 in particular an operating table is firmly connected. Preferably, the operating table is firmly screwed to the rotary unit 16. The operating table is not illustrated in FIG. 1. Alternatively, on the upper side 18 also other medical apparatuses can be mounted. Thus, the device 10 in particular serves as a rotary base for operating tables.

By rotating the rotary unit 16 about its axis of rotation 19 relative to the floor unit 12, thus also the operating table firmly connected to the rotary unit 16 is rotatable about the axis of rotation 19 of the rotary unit 16 so that a patient lying on the operating table can be positioned in a position which is best for the operation. The rotary unit 16 has two recesses 20, 22, in each of which a respective cylinder 24, 26 is arranged. The cylinders 24, 26 are in particular hydraulic cylinders. The cylinders 24, 26 are preferably received in the recesses 20, 22 without any clearance so that the cylinders 24, 26 are firmly connected to the rotary unit 16. The cylinders 24, 26 are formed such that at least one contact area each is movable orthogonally to the floor unit 12 and in that this contact area presses against the floor unit 12 in a locking position. As a result thereof, the rotary unit 16 is lifted relative to the floor unit 12.

In an alternative embodiment of the invention also only one cylinder 24, 26 or more than two cylinders 24, 26 can be provided for lifting the rotary unit 16. Likewise, for lifting the rotary unit 16 also other locking elements can be used.

The floor unit 12 comprises a base unit 28 and a braking ring 30 firmly connected thereto. The braking ring 30 is in particular screwed onto the base unit 28. In an alternative embodiment of the invention, the base unit 28 and the braking ring 30 can also be formed in one piece. In particular, the braking ring 30 has an annular shape. In a preferred embodiment of the invention the braking ring 30 comprises three segments having the form of annular sectors. In particular, these three segments are all identical in shape. The rotary unit 16 has a groove which extends in circumferential direction and in which at least a part of the braking ring 30 is arranged. The groove is in particular formed such that a partial area of the braking ring 30 facing away from the axis of rotation 19 is enclosed by the rotary unit 16.

When the rotary unit 16 is lifted by means of the cylinders 24, 26, then a part of the inner surface of the groove of the rotary unit 16 presses against the braking ring 30 from below so that a contact area of the rotary unit 16 contacts a contact area of the braking ring 30. When the rotary unit 16 is lifted by means of the cylinders 24, 26, while the rotary unit 16 rotates relative to the floor unit 12 about its axis of rotation 19, then a frictional force is generated due to the sliding friction between the rotary unit 16 and the braking ring 30, which frictional force in turn produces a braking torque which is opposite to the rotation of the rotary unit 16 and by which the rotary unit 16 is slowed down until it comes to a standstill.

When the rotary unit 16 does not rotate relative to the floor unit 12 and when the rotary unit 16 is lifted in this state by the cylinders 24, 26, then the rotary unit will generate a locking force as a result of the static friction acting between the contact area of the rotary unit 16 and the contact area of the braking ring 30. The higher the forces exerted by the cylinders 24, 26 on the floor unit 12, the higher the normal forces acting between the contact area of the braking ring 30 and the contact area of the rotary unit 16. The higher these normal forces, the higher the acting static friction and thus also the braking torque.

By the contact of the contact areas of the cylinders 24, 26 with the floor unit 12, a further braking torque is generated. This braking torque is less than the braking torque generated due to friction between the contact area of the rotary unit 16 and the braking ring 30, since the distance from the center axis of a respective cylinder 24, 26 to the axis of rotation 19 of the rotary unit 16 is smaller than the distance from the contact area of the rotary unit 16 to the axis of rotation 19 of the rotary unit 16. The respective distance between a cylinder 24, 26 and the axis of rotation 19 of the rotary unit 16 is in particular half as large as the distance between the contact area of the rotary unit 16 and the axis of rotation 19 of the rotary unit 16. The larger the distance from a cylinder 24, 26 to the axis of rotation 19 of the rotary unit 16, the higher the braking torque produced by means of the respective cylinder 24, 26. Likewise, the braking torque produced due to the friction between the contact area of the rotary unit 16 and the braking ring 30 is the higher, the larger the distance from the contact area of the rotary unit 16 to the axis of rotation 19 of the rotary unit 16. Due to the large distance between the contact area of the rotary unit 16 and the axis of rotation 19 in the embodiment shown in FIG. 1, the braking torque produced by the contact between the braking ring 30 and the rotary unit 16 is relatively high so that a high braking effect and a reliable secure locking of the rotary unit 16 is achieved.

The material of the braking ring 30 and the material of the rotary unit 16 are in particular matched to each other such that the static friction coefficient and the sliding friction coefficient between these materials are as high as possible so that the braking torque has a suitable value. As a result thereof, in particular a compact structure of the device 10 is achieved.

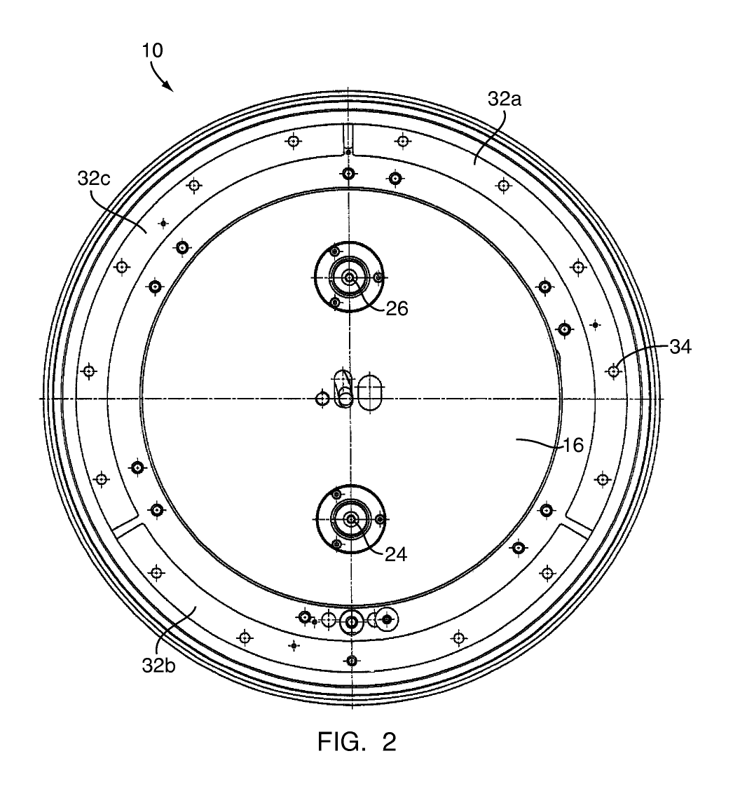

In FIG. 2, a schematic bottom view of the device 10 according to FIG. 1 is illustrated without the base unit 28. Elements having the same structure or the same function are identified with the same reference signs. The braking ring 30 comprises three segments 32a to 32c. In an alternative embodiment of the invention, the braking ring 30 can also be formed of less than three or more than three segments 32a to 32c. Each segment 32a to 32c is firmly connected to the base unit 28 via five screws each. One of these screws is exemplarily identified with the reference sign 34. Alternatively, each of these segments 32a to 32c can also be connected to the base unit 28 with more or less than five screws 34. Further, the segments 32a to 32c can also be firmly connected to the base unit 28 via other connecting elements.

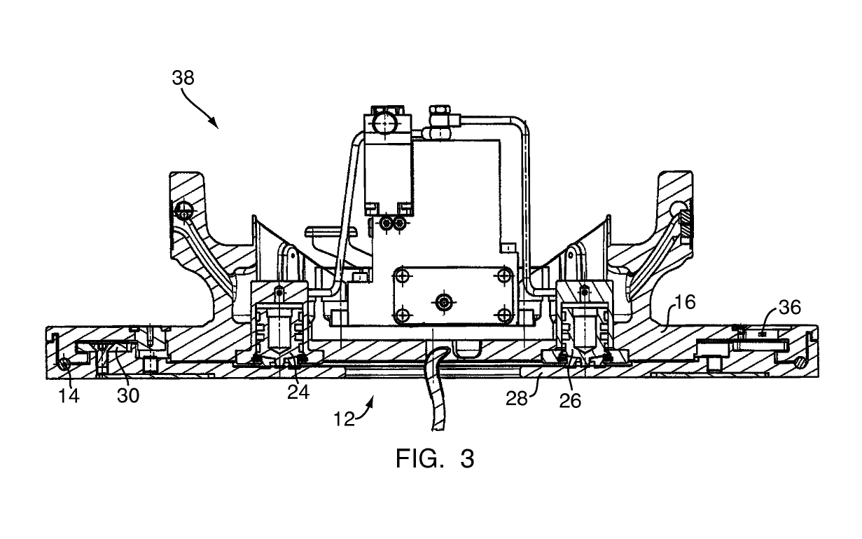

In FIG. 3, a schematic sectional view of a device 38 for rotatably mounting at least one medical apparatus on a floor according to a further embodiment of the invention is shown. In FIG. 3, a plurality of mounting elements and connecting elements for an operating table that can be mounted to the rotary unit 16 are illustrated.

The rotary unit 16 has a mounting aperture 36, which is closable with a cover not illustrated in FIG. 3, for mounting the segments 32a to 32c to the base unit 28. During assembly, the segments 32a to 32c are at first mounted via screws to the side of the rotary unit 16 facing the floor unit 12. Here, the screws are screwed through the rotary unit 16 into the segments 32a to 32c from the side facing away from the floor unit 12. Thereafter, the rotary unit 16 is placed on the base unit 28. In a next step, the screws with which the segments 32a to 32c were fixed to the rotary unit 16 during assembly are again removed. Thereafter, the segments 32a to 32c are screwed to the base unit 28 via the screws 34. Here, the rotary unit 16 is each time rotated such that the mounting aperture 36 is arranged above a screw 34 so that this screw 34 can be inserted, can be screwed into a threaded bore provided in the base unit 28 and can be tightened. Subsequently, the rotary unit 16 is rotated further such that the mounting aperture 36 is arranged above the next threaded bore for mounting the segments 32a to 32c or a further segment 32a to 32c by means of a further screw 34. Then, the next screw 34 is inserted and screwed into the threaded bore. This is repeated until all screws 34 required for mounting the segments 32a to 32c are inserted.

Further, a method for slowing down and/or locking a rotary unit 16 of a device 10, 38 for rotatably mounting at least one medical apparatus on a floor is disclosed. In the method, the rotary unit 16 which is connected to the floor unit 12 rotatably relative thereto about an axis of rotation 19 via at least one bearing unit 14 is lifted by means of at least one locking element 24, wherein the floor unit 12 can be firmly connected to the floor. As a result of the lifting, a contact area of the rotary unit 16 is pressed against a contact area of the floor unit 12 that is complementary to the contact area of the rotary unit 16 for generating a frictional force.

Although the invention above has been described in connection with preferred embodiments of the invention, it will be evident for a person skilled in the art that several modifications are conceivable without departing from the invention as defined by the following claims.

What is claimed is:

1.-13. (canceled)

14. A device for rotatably mounting at least one medical apparatus on a floor, comprising:
a floor unit which can be firmly connected to the floor,
a rotary unit which is connected to the floor unit rotatably relative thereto about an axis of rotation via at least one bearing unit, and
at least one locking element which is firmly connected to the rotary unit for slowing down the rotary unit and for locking the rotary unit,
wherein the locking element, in a braking state, presses against the floor unit for lifting the rotary unit, and
wherein, as a result of the lifting, a contact area of the rotary unit contacts a contact area of the floor unit for producing a braking torque,
wherein the floor unit comprises a base unit and a braking ring,
in that the contact area of the floor unit is formed by the braking ring,
in that the rotary unit has a groove extending in circumferential direction,
in that the contact area of the rotary unit is formed by at least a part of at least one inner surface of the groove, and
in that at least a part of the braking ring is arranged within the groove.

15. The device according to claim 14, wherein the braking torque is a first braking torque and in that the locking element, when pressing against the floor unit, produces a second braking torque as a result of the frictional force acting between a contact area of the locking element and the floor unit.

16. The device according to claim 14, wherein the locking element is a first locking element and in that at least one second locking element, preferably a second, a third, and at least a fourth locking element are provided, wherein the radial distance from the center axes of the locking elements to the axis of rotation is the same each time.

17. The device according to claim 14, wherein the first, the second, the third and/or the fourth locking element each comprise a cylinder.

18. The device according to claim 14, wherein the bearing unit is a ball bearing.

19. The device according to claim 14, wherein on the side of the rotary unit facing away from the floor unit an operating table can be mounted.

20. The device according to claim 14, wherein the coefficient of friction between the material of the rotary unit and the material of the braking ring is higher than the coefficient of friction between the material of the rotary unit and the material of the base unit.

21. The device according to claim 14, wherein the radial distance from the center line of the contact area of the rotary unit to the axis of rotation is larger than the radial distance from the center point of the locking element to the axis of rotation.

22. The device according to claim 14, wherein the radial distance from the center line of the contact area of the rotary unit to the axis of rotation has a value in the range between 80% and 95% of the radius of the rotary unit.

23. The device according to claim 14, wherein the contact area of the rotary unit and/or the contact area of the floor unit has an annular shape.

24. A method for slowing down and/or locking a rotary unit of a device for rotatably mounting at least one medical apparatus on a floor,
in which the rotary unit which is connected to the floor unit rotatably relative thereto about an axis of rotation via at least one bearing unit is lifted by means of at least one locking element, wherein the floor unit can be firmly connected to the floor, and
in which, as a result of the lifting, a contact area of the rotary unit is pressed against a contact area of the floor unit that is complementary to the contact area of the rotary unit for generating a frictional force,
wherein a floor unit is used which comprises a base unit and a braking ring, wherein the contact area of the floor unit is formed by the braking ring,
in that in the rotary unit a groove extending in circumferential direction is provided, wherein the contact area of the rotary unit is formed by at least a part of at least one inner surface of the groove, and
in that at least a part of the braking ring is arranged within the groove.
